(19) United States
(12) Patent Application Publication
(10) Pub. No.: US 2021/0063941 A1
(43) Pub. Date: Mar. 4, 2021

(54) IMAGE CARRIER UNIT AND IMAGE FORMING APPARATUS

(71) Applicant: Oki Data Corporation, Tokyo (JP)

(72) Inventors: Takaaki EBE, Tokyo (JP); Toshiyuki SATO, Tokyo (JP)

(21) Appl. No.: 16/998,033

(22) Filed: Aug. 20, 2020

(30) Foreign Application Priority Data
Aug. 29, 2019 (JP) 2019-156673

(51) Int. Cl. G03G 21/00; G03G 5/05; G03G 15/00

(52) U.S. Cl. CPC G03G 21/0011; G03G 15/75; G03G 5/056

(57) ABSTRACT

An image carrier unit includes an image carrier that makes a rotation and has a photosensitive layer on an outer surface, the photosensitive layer containing a binding resin and at least one type of charge transporting material and covering the surface, and a cleaning blade that has a contact part contacting the surface of the image carrier and removes residue on the surface of the image carrier accompanying the rotation of the image carrier. A photosensitive ratio of a first product to a second product is 183.0 or higher and 233.9 or lower, the first product is obtained from a weight-average molecular weight (A) of the binder resin multiplied by an added ratio (B) of the binder resin in the photosensitive layer, and the second product is obtained from a weight-average molecular weight (C) of the charge transporting material multiplied by an added ratio (D) of the charge transporting material.

### TECHNICAL FIELD

This application discloses an image carrier unit and an image forming apparatus that form an image using an electrophotographic process.

### BACKGROUND

Conventional image carrier unit and image forming apparatus form an electrostatic latent image by having an exposure device expose the surface of a photosensitive drum as an image carrier charged uniformly by a charging roller, a development roller develop the electrostatic latent image and form a toner image as a developer image on the photosensitive drum surface, afterwards a transfer roller transfer the toner image to a medium, and a fuser fuse it. Also, toner as a developer adheres to the photosensitive drum after the toner image is transferred to the medium, and a cleaning member removes the toner.

Generally used as the photosensitive drum is a stacked photosensitive body where a charge generation layer and a charge transportation layer are stacked in this order on a conductive supporting body. In forming a photosensitive layer of the stacked photosensitive body having the charge generation layer and the charge transportation layer, in order to secure film strength, a binder resin is used for dispersing compounds. Also, the charge transportation layer is obtained by applying and drying an application liquid that is obtained by dissolving or dispersing a charge transporting substance and various binder resins in a solvent.

### RELATED ART

[Patent Doc. 1] JP Laid-Open Patent Application Publication 2007-179038 SUBJECT(S) TO BE SOLVED

However, in the conventional technology, there is a drawback that a print density decreases.

An embodiment(s) of invention has an objective of solving such a problem and aims at suppressing the occurrences of dusty dirt on images.

### SUMMARY

An image carrier unit, disclosed in the application, includes an image carrier that makes a rotation and has a photosensitive layer on an outer surface, the photosensitive layer containing a binding resin and at least one type of charge transporting material and covering the surface, and a cleaning blade that has a contact part contacting the surface of the image carrier and removes residue on the surface of the image carrier accompanying the rotation of the image carrier. A photosensitive ratio of a first product to a second product is 183.0 or higher and 233.9 or lower, the first product is obtained from a weight-average molecular weight (A) of the binder resin multiplied by an added ratio (B) of the binder resin in the photosensitive layer, and the second product is obtained from a weight-average molecular weight (C) of the charge transporting material multiplied by an added ratio (D) of the charge transporting material.

Obtained by an embodiment of invention designed in this manner is an effect that the occurrences of dusty dirt on images can be suppressed.

### BRIEF DESCRIPTION OF THE DRAWINGS

FIG. 1 is an outline side cross-sectional view showing the configuration of a development device in the first embodiment.

FIG. 2 is an outline side cross-sectional view showing the configuration of an image forming apparatus in the first embodiment.

FIG. 3 is a block diagram showing the control configuration of the image forming apparatus in the first embodiment.

FIGS. 4A and 4B are explanatory diagrams of the method of measuring the resistance value of a development roller in the first embodiment.

FIG. 5 is an explanatory diagram of a cleaning angle in the first embodiment.

FIG. 6 is an explanatory diagram showing the configuration of a photosensitive drum in the first embodiment.

FIGS. 7A and 7B are explanatory diagrams of dusty dirt in the first embodiment.

FIG. 8 is an explanatory diagram of the method of measuring a post-exposure potential of the photosensitive drum in the first embodiment.

FIG. 9 is an explanatory diagram of a solid pattern in the first embodiment.

FIG. 10 is an explanatory diagram of a blank pattern in the first embodiment.

FIG. 11 is a plot of a molecular weight distribution in the first embodiment.

FIG. 12 is an explanatory diagram of a charge transportation layer in the first embodiment.

FIGS. 13A to 13D are explanatory diagrams of actions of the charge transportation layer in the first embodiment.

FIGS. 14A and 14B are explanatory diagrams of the method of measuring Martens hardness in the second embodiment.

FIG. 15 is an explanatory diagram of an indentation test in the second embodiment.

FIG. 16 shows Table 1

FIG. 17 shows Table 2

### DETAILED DESCRIPTION OF THE PREFERRED EMBODIMENT(S)

Below, embodiments of the image carrier unit and the image forming apparatus by this invention are explained referring to drawings.

### Embodiment 1

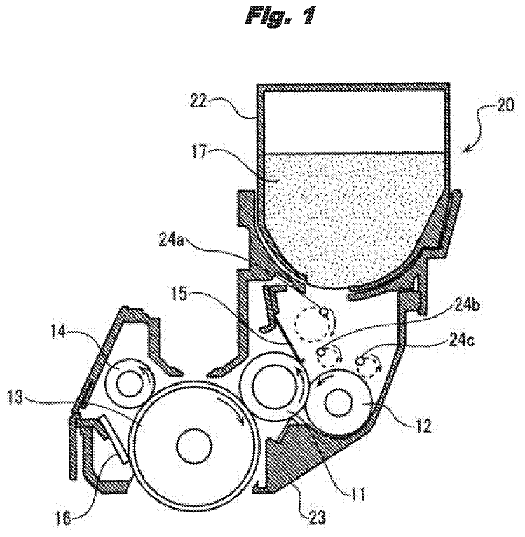

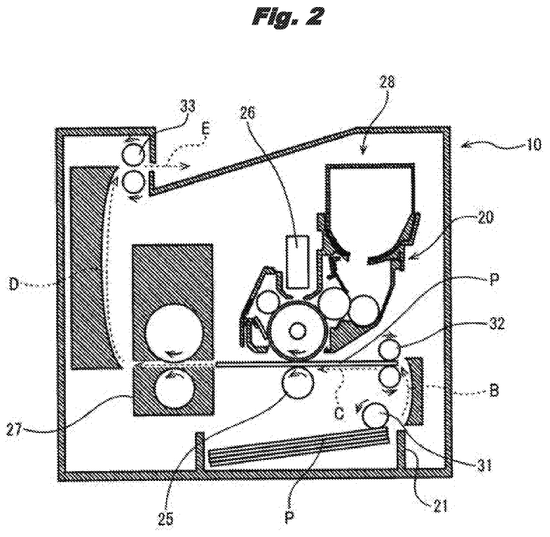

FIG. 1 is an outline side cross-sectional view showing the configuration of a development device in the first embodiment, and FIG. 2 is an outline side cross-sectional view showing the configuration of an image forming apparatus in the first embodiment.

In FIG. 2, the image forming apparatus 10 forms a developer image on a medium and can be any kind such as a printer, a facsimile machine, a copier, or a multifunction peripheral (MFP). Explanations in this embodiment are given assuming that the image forming apparatus 10 is an electrophotographic printer that forms an image by an electrophotographic system. Note that although the image forming apparatus 10 can be an apparatus that forms a color image, for convenience of explanation, it is assumed to be an apparatus that forms a monochromatic image.

Inside the image forming apparatus 10, a sheet cassette 21, an image forming unit 28, and a fuser 27 are arranged along a carrying route of a recording medium P.

The sheet cassette 21 accommodates the recording medium P. The recording medium P set stacked in the sheet cassette 21 is fed by a sheet feeding roller 31 as a single piece separated from the rest, carried in a medium carrying direction indicated with an arrow B, and sent to a sheet carrying roller 32.

The image forming unit 28 has a development device 20, forms a toner image as a developer image, and transfers it to the recording medium P. The recording medium P sent into the sheet carrying roller 32 is sent out by the sheet carrying roller 32 in a medium carrying direction indicated with an arrow C at a certain timing, and in the middle of being carried along the carrying route, a toner image formed by the image forming unit 28 is transferred by a transfer roller 25.

An LED head 26 is an exposure device provided with LEDs (Light Emitting Diodes) as light-emitting elements.

A fuser 27 fuses the toner image transferred to the recording medium P with heat and pressure. Once the recording medium P is sent into the fuser 27, a fusing process is performed by the fuser 27, thereby the toner image is fused onto the recording medium P.

The recording medium P with the toner image fused is carried in a direction indicated with an arrow D, ejected by a sheet ejection roller 33 in a direction indicated with an arrow E, and accommodated by a stacker outside the image forming apparatus 10.

As shown in FIG. 1, the development device 20 as an image carrier unit is provided with a toner accommodating part 22 as a developer container, and a casing 23 that internally accommodates toner 17 as a developer supplied from the toner accommodating part 22.

Also, the development device 20 is provided with a photosensitive drum 13 as an electrostatic latent image carrier (image carrier), a development roller 11 as a developer carrier arranged opposing the photosensitive drum 13, a toner supply roller 12 as a developer supply member that supplies toner 17 to the development roller 11, a charging roller 14 as a charging member that charges the photosensitive drum 13, a development blade 15 as a toner layer thickness regulating blade that forms a thin layer of toner 17 supplied onto the development roller 11, stirring members 24a, 24b, and 24c for maintaining fluidity of toner 17 inside the casing 23, and a cleaning blade 16 for scraping off and recovering transfer residual toner on the photosensitive drum 13.

The cleaning blade 16 as a removal member has a contact part that contacts the surface of the photosensitive drum 13, and is a plate-shaped object that removes residue on the surface of the photosensitive drum 13 as the photosensitive drum 13 rotates.

The development roller 11, the toner supply roller 12, the photosensitive drum 13, and the charging roller 14 each rotate in their respective directions indicated with arrows. The stirring members 24a, 24b, and 24c are crank-shaped bars, and rotate in directions indicated with arrows on broken lines shown in FIG. 1.

Also, the LED head 26 shown in FIG. 2 forms an electrostatic latent image by exposing the surface of the photosensitive drum 13 based on image data.

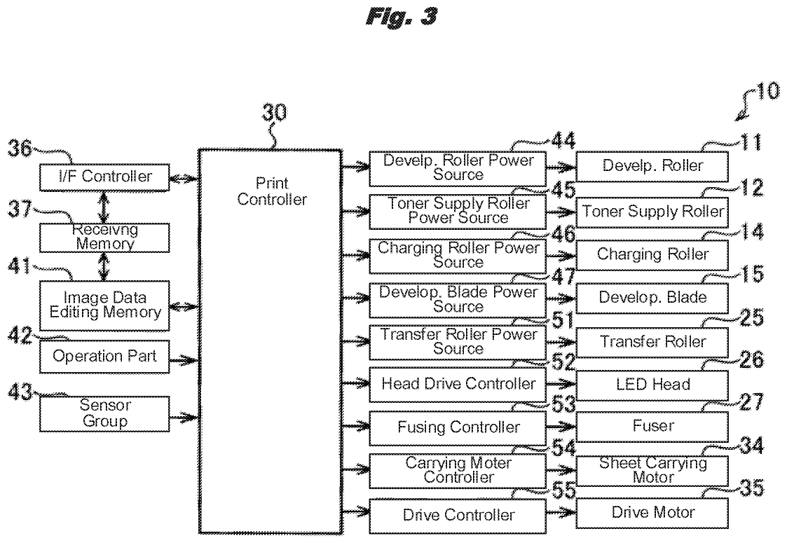

FIG. 3 is a block diagram showing the control configuration of the image forming apparatus in the first embodiment.

In FIG. 3, the image forming apparatus 10 has a print controller 30, an I/F controller 36, an operation part 42, a sensor group 43, a development roller power source 44, a toner supply roller power source 45, a charging roller power source 46, a development blade power source 47, a transfer roller power source 51, a head drive controller 52, a fusing controller 53, a carrying motor controller 54, and a drive controller 55.

The print controller 30 is provided with a microprocessor as a control means, ROM (Read Only Memory) and RAM (Random Access Memory) as memory means, an input/output port, a timer, etc., receives print data and control commands from an upper level device such as a host computer through the I/F (interface) controller 36, and controls the whole sequence of the image forming apparatus 10 to have a print operation performed.

Receiving memory 37 temporarily records the print data inputted through the I/F controller 36 from the upper level device.

Image data editing memory 41 receives the print data recorded in the receiving memory 37 and stores image data formed by edit-processing the print data.

The operation part 42 is provided with a display means such as LEDs for displaying the state of the image forming apparatus 10, and an input means such as switches for giving instructions from an operator to the image forming apparatus 10.

The sensor group 43 includes various sensors for monitoring the operation state of the image forming apparatus 10, such as a sheet position detection sensor, a temperature/humidity sensor, a print density sensor, and a toner remaining amount detection sensor.

The charging roller power source 46 applies a voltage to the charging roller 14 according to an instruction of the print controller 30, thereby charging the surface of the photosensitive drum 13.

The development roller power source 44 applies a prescribed voltage to the development roller 11 for having toner 17 adhere to an electrostatic latent image.

The toner supply roller power source 45 applies a prescribed voltage to the toner supply roller 12 for supplying toner 17 to the development roller 11.

The development blade power source 47 applies a prescribed voltage to the development blade 15 for forming a thin layer of toner 17 on the surface of the development roller 11.

The transfer roller power source 51 applies a prescribed voltage to the transfer roller 25 for transferring a toner image formed on the photosensitive drum 13 to the recording medium.

Note that the charging roller power source 46, the development roller power source 44, the toner supply roller power source 45, the development blade power source 47, and the transfer roller power source 51 can change the voltages applied to the individual members (the charging roller 14, the development roller 11, the toner supply roller 12, the development blade 15, and the transfer roller 25) according to instructions from the print controller 30.

The head drive controller 52 sends the image data recorded in the image data editing memory 41 to the LED head 26 shown in FIG. 2, and drives the LED head 26.

The fusing controller 53 applies a voltage to the fuser 27 as a fusing means for fusing the transferred toner image to the recording medium. Note that the fuser 27 is provided with a heater for melting toner constituting the toner image on the recording medium, a temperature sensor that detects temperature, etc. The fusing controller 53 reads a sensor output of the temperature sensor, electrifies the heater based on the sensor output, and controls so that the fuser 27 becomes constant temperature.

The carrying motor controller 54 controls a sheet carrying motor 34 for carrying the recording medium. The carrying motor controller 54 carries or stops the recording medium at prescribed timings according to instructions of the print controller 30. Note that the sheet feeding roller 31, the sheet carrying roller 32, and the sheet ejection roller 33 are rotated by the sheet carrying motor 34. Then, the recording medium P shown in FIG. 2 is carried in the directions indicated with the arrows B˜E.

The drive controller 55 drives a drive motor 35 for having the photosensitive drum 13 operate. Once the drive motor 35 is driven by the drive controller 55, as shown in FIG. 1, the photosensitive drum 13 is rotated in a direction indicated with an arrow, and the charging roller 14, the development roller 11, and the toner supply roller 12 are rotated in directions indicated with arrows, respectively.

Next, main components of the development device 20 are explained in detail based on FIG. 1.

First, toner 17 is explained.

Toner 17 used in this embodiment is nonmagnetic one-component negatively-chargeable toner that is toner base particles containing at least a binding resin with an external additive such as inorganic fine powder or organic fine powder added. As this binding resin, although not particularly limited, preferable are polyester based resin, styrene-acrylic resin, epoxy based resin, or styrene-butadiene based resin. To this binding resin, a release agent, a coloring agent, etc. are added, and other than that, additives such as a charge control agent, a conductivity modifier, a fluidity improver, and a cleanability improver may be added as appropriate. Also, as the binding resin, multiple types can be mixed, and in this embodiment, other than multiple amorphous polyester based resins, a crystalline polyester resin having a crystal structure was used.

The average particle size of toner 17 is 6.0 [μm], and its circularity is 0.96. Note that the average particle size was measured using Coulter Multisizer 3 manufactured by Coulter Corporation, and the circularity was for measured using a flow-type particle image analyzer FPIA-3000 manufactured by Sysmex Corporation.

As the release agent, although not particularly limited, listed as examples are publicly-known ones such as copolymers of low molecular weight polyethylene, low molecular weight polypropylene, and olefin, aliphatic hydrocarbon based waxes such as microcrystalline wax, paraffin wax, and Fischer-Tropsch wax, oxides of aliphatic hydrocarbon based waxes such as oxidized polyethylene wax or their block copolymers, waxes containing fatty acid esters such as carnauba wax and montanic acid ester wax as the main ingredients, and partially or totally deoxidized fatty acid esters such as deoxidized carnauba wax. Then, the added content should be 0.1˜20 pts. wt., preferably 0.5˜12 pts. wt., per the binding resin 100 pts. wt. to be effective, and using multiple waxes together is also preferable.

As the coloring agent, although not particularly limited, dyes, pigments, etc. used as coloring agents for the conventional black, yellow, magenta, and cyan toners can be used either singly or as a combination of multiple kinds. Listed as examples are carbon black, oxidized iron, Phthalocyanine Blue, Permanent Brown FG, Brilliant Fast Scarlet, Pigment Green B, Rhodamine-B base, Solvent Red 49, Solvent Red 146, Pigment Blue 15:3, Solvent Blue 35, quinacridone, Carmine 6B, and Disazo Yellow. The added content of this coloring agent should be 2˜25 pts. wt., preferably 2˜15 pts. wt., per the binding resin 100 pts. wt.

As the charge control agent, publicly-known ones can be used. Listed as examples in the case of negatively-chargeable toner are azo based complex charge control agents, salicylic acid complex charge control agents, calixarene based charge control agents, etc. The added content of this charge control agent should be 0.05˜15 pts. wt., preferably 0.1˜10 pts. wt. per the binding resin 100 pts. wt.

The external additives of toner 17 are added for improving environmental stability, charge stability, developability, fluidity, and preservability, and publicly-known ones can be used. The added amount should be 0.01˜10 pts. wt., preferably 0.05˜8 pts. wt., per the binding resin 100 pts. wt. In this embodiment, per the base particles 100 pts. wt., several types (positive and negative in charge polarity) of silica of 14 [μm] in average particle size, colloidal silica (negatively-charged) of 110 [μm] in average particle size, and melanin (positively-charged) of 200 [μm] in average particle size were added, and the total amount was fit within the above-mentioned range.

The charge amount (blow-off charge amount) of toner 17 was measured by stirring toner and carrier by shaking. Here, using ferrite carrier “EF96-35” manufactured by Powdertech Co., Ltd. as carrier, toner 0.5 [g] and carrier 9.5 [g] were mixed. The toner-carrier mixture (150 [mg]) was accommodated in a container and shaken using a shaker “YS-LD” manufactured by YAYOI Co., Ltd. The number of shaking was set to 200 [times/minute], and the shaking time was set to 300 seconds.

After shaking, using a powder charge amount measurement device “TB-203” manufactured by KYOCERA Chemical Corporation, 10-second suction was performed with blow pressure of 7.0 [kPa] and suction pressure of −4.5 [kPa], and the charge amount and the suction amount were outputted to a PC (personal computer) at every 0.1 second. The charge amount per unit weight Q/M of toner particles calculated from the average values of charge amounts and suction amounts outputted for the last 2 seconds of the suction time (10 seconds) was about −35 [μC/g]. Note that the measurements were performed at temperature of 25 [° C.] and relative humidity of 50 [%].

The development roller 11 is provided with an elastic layer installed on a conductive core metal as a shaft, and a surface layer coating the surface of the elastic layer.

In general, the rubber hardness of the elastic layer in a rolled shape should preferably be 55˜80 [° ] in Asker-C hardness. If the Asker-C hardness of the elastic layer is lower than 55 [° ], when the development device 20 is not operated over a long period of time, dents occur on parts of the development roller 11 in contact with the photosensitive drum 13 and the development blade 15, generating lateral streaks on a printed image. Also, if the Asker-C hardness of the elastic layer is higher than 80 [° ], a mechanical load on the development roller 11 becomes large, making toner filming easy to occur on the surface of the development roller 11. In this embodiment, the Asker-C hardness of the elastic layer was set to 76 [° ].

As the material of the elastic layer, a general rubber material such as silicone rubber or urethane can be used. If polyurethane is used as the elastic layer, preferable is polyurethane having polyether based polyol as its main ingredient. Ether based polyurethane is so-called casting-type polyurethane obtained by reacting polyol having polyether based polyol as its main ingredient with polyisocyanate. This is for reducing compression permanent strain. On the other hand, if ester based polyurethane is used, because its hydrolytic property is poor, it cannot be used stably over a long period of time.

Also, if polyurethane is used as the elastic layer, as isocyanate to be reacted with polyol, for example, trifunctional isocyanate as standalone such as triphenylmethane triisocyanate, tris(isocyanatophenyl) thiophosphate, or bicycloheptane triisocyanate, nulate modified polyisocyanate of hexamethylene diisocyanate, or a mixture such as polymeric MDI can be used.

Also, it can be a mixture of these polyisocyanates with three or more functional groups and a general bifunctional isocyanate compound. Listed as examples of bifunctional isocyanate compound are 2,4-tolylene diisocyanate (TDI), 4,4-diphenylmethane diisocyanate (MDI), paraphenylene diisocyanate (PPDI), 1,5-naphthalene diisocyanate (NDI), 3,3-dimethyldiphenyl-4,4-diisocyanate (TODI), and modified products and multimers such as prepolymers having these isocyanates at both terminals.

The elastic layer is formed by adding carbon black to such a rubber base material as mentioned above and applying heat to harden it while retaining the dispersion state of carbon. Thereby, carbon black showing specific resistance of about 0.1˜10 [Ω·cm] can be dispersed in elastomer (1012˜1016 [Ω·cm]) that can be regarded as an insulator to form a medium-resistance region of 104˜108 [Ω·cm] in a stable state.

In this embodiment, the surface layer was formed by impregnating the surface layer part of the elastic layer with a surface treatment liquid. The surface treatment liquid is an organic solvent with at least an isocyanate ingredient dissolved. Listed as examples of the organic solvent are methyl acetate, butyl acetate, pentyl acetate, etc. When using such an organic solvent, for example, as the isocyanate ingredient contained in the surface treatment liquid, an isocyanate compound such as 2,4-tolylene diisocyanate (TDI) or 4,4-diphenylmethane diisocyanate (MDI), or the above-mentioned multimer or modified product can be used.

The surface treatment liquid can contain a polyether based polymer. Here, the polyether based polymer should preferably be soluble in an organic solvent. Also, it should preferably have active hydrogen and can react and chemically bond with an isocyanate compound. Listed as examples of preferable polyether based polymer having active hydrogen are polymers having a hydroxyl group or allyl group such as polyol and glycol used for isocyanate-terminated prepolymers.

Also, the surface treatment liquid can contain a polymer selected from acrylic fluorine based polymers and acrylic silicone based polymers. The acrylic fluorine based polymers and the acrylic silicone based polymers are soluble in a prescribed solvent and can react and chemically bond with the isocyanate compound. The acrylic fluorine based polymers are solvent-soluble fluorine based polymers having a hydroxyl group, alkyl group, or carboxyl group for example, and listed as examples are a block copolymer of acrylic ester and alkyl fluoride acrylate and its derivative. Also, the acrylic silicone based polymers are solvent-soluble silicone based polymers, and listed as examples are a block copolymer of acrylic ester and acrylic acid siloxane ester and its derivative.

Also, to the surface treatment liquid, carbon black such as acetylene black can be further added as a conductivity imparting agent.

The total amount of polyether based polymers, acrylic fluorine based polymers, and acrylic silicone based polymers in the surface treatment liquid should preferably be 10˜70 wt. % relative to the isocyanate ingredient. If it is lower than 10 wt. %, the effect of retaining carbon black etc. in the surface treatment liquid decreases. On the other hand, if it is higher than 70 wt. %, its electric resistance value can increase, and the relative amount of the isocyanate ingredient decreases, preventing an effective surface treatment layer from forming, that is a problem.

By applying the above-mentioned surface treatment liquid to the elastic layer through dipping, and dry-hardening it, the surface layer part is impregnated with the surface treatment liquid to become the surface layer.

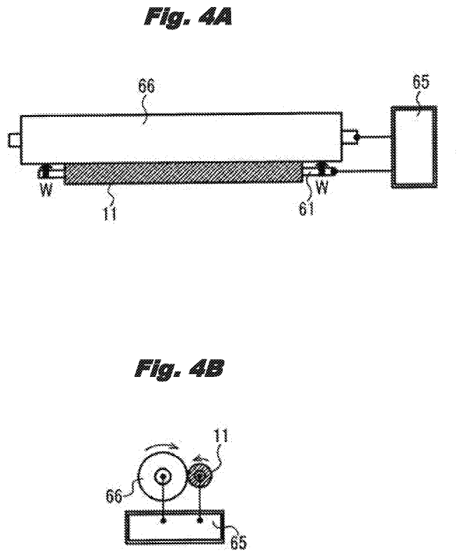

The resistance value of the development roller 11 was measured by a method shown in FIG. 4 using a high-resistance meter (Model No.: 4339B) 65 manufactured by Hewlett Packard Company. As shown in FIG. 4a, the development roller 11 was given loads of W=300 [g] hung on both axial ends, and placed into contact with a metal roller 66 made of SUS (Steel Use Stainless) of 30 [mm] in diameter. The metal roller 66 was rotated at a speed of 50 [rpm], a voltage of ˜100 [V] was applied to the core metal 61 of the development roller 11, measurements were performed on 100 points per one round of the development roller 11, and their average value was regarded as the resistance value of the roller. At this time, the resistance value of the development roller 11 should preferably be within a range of 1×104˜1×107 [Ω], and in this embodiment a development roller having a resistance value of 1×105 [Ω] was used.

Note that FIG. 4b is a diagram viewing the development roller 11 and the metal roller 66 in the axial direction.

Next, explained are the development blade 15 and the cleaning blade 16.

The development blade 15 in this embodiment is made of stainless steel of 0.08 [mm] in plate thickness, a bending process is applied to a part in contact with the development roller 11 with a curvature radius of 0.18 [mm], and its pressure (linear pressure) to the development roller 11 is 40 [gf/cm].

In view of the setting condition of the development blade 15, in order to make the toner layer thickness and the toner charge amount on the development roller 11 to desired amounts, the surface roughness, the resistance value, etc. of the development roller 11 need to be considered. The appropriate surface roughness of the development roller 11 used in this embodiment is 2˜10 [μm] in 10-point average roughness Rz (JIS B0601-1994) in the circumferential direction.

The cleaning blade 16 used in this embodiment consists of a plate-shaped elastic body and a conductive plate-shaped holder for holding it.

As a forming material of the plate-shaped elastic body, although not particularly limited, in general an elastic composition is used so as not to damage the surface of the photosensitive drum 13 when scraping off residual toner by slide-contacting the photosensitive drum surface. Listed as an example is a composition that an appropriate additive is mixed to polyurethane, silicone resin, fluororesin, fluororubber, or the like. Among them, preferable is a polyurethane composition in its excellent mechanical strength and elastic pressure contact.

The above-mentioned polyurethane composition can usually be obtained using polyisocyanate, polyol, a hardening agent, and a catalyst.

As the above-mentioned polyisocyanate, although not particularly limited, listed as examples are diisocyanates such as 4,4′-diphenylmethane diisocyanate (MDI), 2,4-tolylene diisocyanate (2,4-TDI), 2,6-tolylene diisocyanate (2,6-TDI), 3,3′-tolylene-4,4′-diisocyanate, 3,3′-dimethyldiphenylmethane-4,4′diisocyanate, 2,4-tolylene diisocyanate uretidinedione (dimer of 2,4-TDI), 1,5-naphthylene diisocyanate, metaphenylene diisocyanate, hexamethylene diisocyanate, isophorone diisocyanate, 4,4′-dicyclohexylmethane diisocyanate (water-added MDI), carbodiimide modified MDI, orthotoluidine diisocyanate, xylene diisocyanate, paraphenylene diisocyanate, and lysine diisocyanate methyl ester, triisocyanates such as triphenylmethane-4,4′,4″-triisocyanate, and polymeric MDI. These can be used either singly or as a combination of two or more kinds. Among all, MDI is preferable in view of its wear resistance.

Also, as the polyol used together with the polyisocyanate mentioned above, although not particularly limited, listed as examples are polyester polyols such as polyethylene adipate (PEA), polybutylene adipate (PBA), and polyhexylene adipate, and polyether polyols such as polycaprolactone, polyoxytetramethylene glycol, and polyoxypropylene glycol. These are used either singly or as a combination of two or more kinds. Among all, PBA is preferable in its excellent wear resistance.

As the hardening agent used together with polyisocyanate and polyol mentioned above, although not particularly limited, listed as examples are polyols of molecular weight 300 or lower such as 1,4-butanediol, ethylene glycol, diethylene glycol, propylene glycol, dipropylene glycol, hexanediol, 1,4-cyclohexanediol, 1,4-cyclohexanedimethanol, xylene glycol, triethylene glycol, trimethylolpropane, glycerine, pentaerythritol, sorbitol, and 1,2,6-hexanetriol. These are used either singly or as a combination of two or more kinds.

The linear pressure of the cleaning blade 16 to the photosensitive drum 13 should desirably be 15 [gf/cm] or higher and 30 [gf/cm] or lower, and was set to 20 [gf/cm] in this embodiment. Also, it was arranged so that the cleaning angle would become 10 [° ] or higher and 15 [° ] or lower.

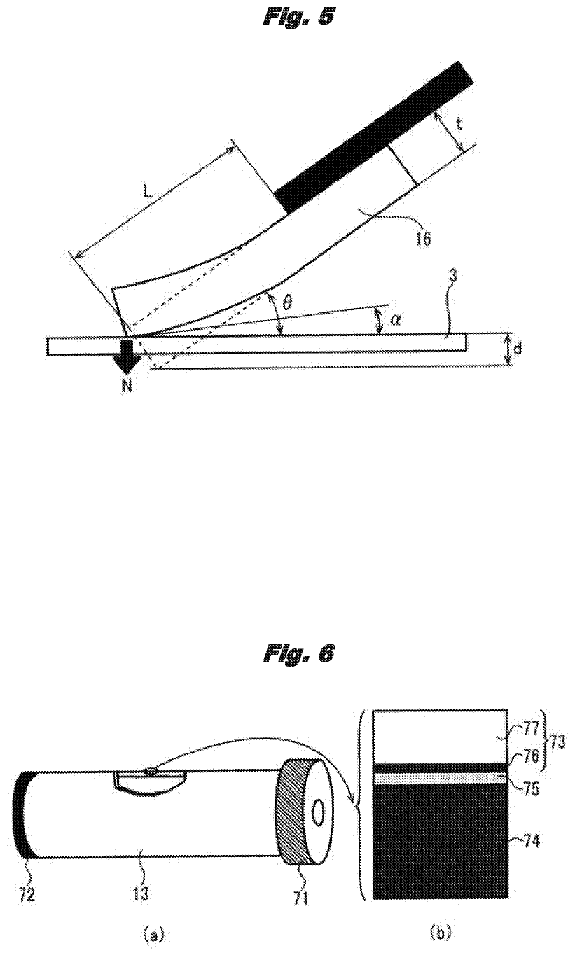

Here, the cleaning angle is explained based on FIG. 5.

In FIG. 5, if denoted as L is the free length of the cleaning blade 16, t is the thickness of the cleaning blade 16, E is the Young's modulus of the cleaning blade 16, θ is the set angle of the cleaning blade 16, α is the contact angle between the cleaning blade 16 and the photosensitive drum 13 in the contact part, d is the biting amount of the cleaning blade 16 to the photosensitive drum 13, and N is the load of the cleaning blade 16 to the photosensitive drum 13, the biting amount d is expressed as

d=NbL³/3EI Eq. A (b is the length of the cleaning blade 16),

and the deflection angle (θ−α) of the cleaning blade 16 as

tan(θ−α)=NbL²/2EI Eq. B,

where I in Eqs. A and B is the cross-sectional secondary moment of the cleaning blade 16, therefore,

I=bt³/12 Eq. X

is derived.

By substituting this into Eqs. A and B, the load N and the contact angle α are expressed as

N=dEt³/4L³,

α=θ−tan⁻¹(3d/2L),

and this contact angle α is adopted as the cleaning angle.

FIG. 6 is an explanatory diagram showing the configuration of the photosensitive drum in the first embodiment.

As shown in (a) of FIG. 6, the photosensitive drum 13 as an image carrier has a drum gear 71 and a drum flange 72, and as shown in (b) of FIG. 6, the surface layer of the photosensitive drum 13 has a stacked structure configured of an undercoat layer 75, a charge generation layer 76, and a charge transportation layer 77 sequentially from the surface on a conductive supporting body 74 processed into a cylindrical shape, where the photosensitive layer 73 is configured of the charge generation layer 76 and the charge transportation layer 77.

Between the conductive supporting body 74 and the below-mentioned photosensitive layer 73, the undercoat layer 75 can be installed for improving adhesiveness, blocking, etc.

Used as the undercoat layer 75 is a resin, a resin having particles of metal oxide etc. dispersed, or the like for example. Also, the undercoat layer 75 can be either a single layer or multiple layers installed.

Listed as examples of metal oxide particles used for the undercoat layer 75 are particles of metal oxide containing one type of metallic element such as titanium oxide, aluminum oxide, silicon oxide, zirconium oxide, zinc oxide, or iron oxide, particles of metal oxide containing multiple metallic elements such as calcium titanate, strontium titanate, or barium titanate. These can be used either singly as one type or as a combination of two or more types in arbitrary ratios and assemblage.

Among these metal oxide particles, titanium oxide and aluminum oxide are preferable, and titanium oxide is especially preferable. Titanium oxide particles can have their surfaces treated with an inorganic matter such as tin oxide, aluminum oxide, antimony oxide, zirconium oxide, or silicon oxide, or an organic matter such as stearin acid, polyol, or silicone.

This treatment can be either any one type or two or more types applied. As the crystal type of titanium oxide particles, for example, any one of the rutile, anatase, brookite, and amorphous types can be used. Note that titanium oxide particles can contain either only one type of crystal type or two or more types of crystal types in arbitrary ratios and assemblage.

Although the particle size of the metal oxide particles is arbitrary unless it significantly damages the effects of this invention, in view of the properties of a binder resin etc. that are raw materials of the undercoat layer 75 and stability of the solution, usually the average primary particle size should desirably be 10 [nm] or larger and 100 [nm] or smaller, preferably 50 [nm] or smaller. This average primary particle size can be measured using a transmission electron microscope (TEM) for example.

The undercoat layer 75 should preferably be formed of a binder resin having metal oxide particles dispersed. Such undercoat layer 75 should preferably be formed by dispersing the metal oxide particles in a solution where the binder resin is dissolved, and applying this solution where the metal oxide particles are dispersed (hereafter, called “undercoat layer forming application liquid” as appropriate). Listed as examples of the binder resin used for the undercoat layer 75 are epoxy resin, polyethylene resin, polypropylene resin, acrylic resin, methacrylic resin, polyamide resin, vinyl chloride resin, vinyl acetate resin, phenol resin, polycarbonate resin, polyurethane resin, polyimide resin, vinylidene chloride resin, polyvinyl acetal resin, vinyl chloride—vinyl acetate copolymer, polyvinyl alcohol resin, polyurethane resin, polyacrylic acid resin, polyacrylamide resin, polyvinyl pyrrolidone resin, polyvinyl pyridine resin, water-soluble polyester resin, cellulose ester resins such as nitrocellulose, cellulose ether resin, casein, gelatin, polyglutamic acid, starch, starch acetate, amino starch, organic zirconium compounds such as zirconium chelate compound and zirconium alkoxide compound, organic titanyl compounds such as titanyl chelate compound and titanyl alkoxide compound, and silane coupling agent. These can be used either singly as one type or as a combination of two or more types in arbitrary ratios and assemblage. Also, it can be used together with a hardening agent in a hardened form. Among all, alcohol-soluble copolyamide, modified polyamide, etc. show good dispersibility and applicability, and thus are preferable.

As the configuration of the photosensitive layer 73, any configuration applicable to publicly-known electrophotographic photosensitive bodies can be adopted. Listed as specific examples are a so-called monolayer photosensitive body having a monolayer photosensitive layer where a photoconductive material is dissolved or dispersed in a binder resin (that is, monolayer photosensitive layer), and a so-called stacked-layer photosensitive body having a photosensitive layer consisting of multiple layers formed by stacking the charge generation layer 76 containing a charge generating substance and the charge transportation layer 77 containing a charge transporting substance (that is, a stacked photosensitive layer), etc. In general, it is known that a photoconductive material shows equivalent performances as its function in either a monolayer type or a stacked type.

Although the photosensitive layer that the electrophotographic photosensitive body of this invention has can be in any of publicly-known forms, comprehensively considering the mechanical properties, electric properties, manufacturing stability, etc. of the electrophotographic photosensitive body, a stacked electrophotographic photosensitive body is preferable. Especially preferable is a sequentially-stacked photosensitive body where the charge generation layer 76 and the charge transportation layer 77 are stacked in this order on the conductive supporting body.

In forming the photosensitive layers of the charge transportation layer of a function-separated photosensitive body (that is, a stacked photosensitive body) having the charge generation layer 76 and the charge transportation layer 77 or the monolayer photosensitive body, a binder resin for dispersing a compound is usually used for securing the film strength. The charge transportation layer of the function-separated photosensitive body can be obtained by applying and drying an application liquid obtained by dissolving or dispersing a charge transporting substance and various binder resins in a solvent. Also, the monolayer photosensitive body can be obtained by applying and drying an application liquid obtained by dissolving or dispersing a charge generating substance, a charge transporting substance, and various binder resins in a solvent.

Although the binder resin normally used for the charge generation layer 76 in the function-separated photosensitive body can be selected from polyvinyl acetal based resins such as polyvinyl butyral resin, polyvinyl formal resin, and partially acetalized polyvinyl butyral resin where part of butyral is modified by formal, acetal, etc., polyarylate resin, polycarbonate resin, polyester resin, modified ether based polyester resins, phenoxy resin, polyvinyl chloride resin, polyvinylidene chloride resin, polyvinyl acetate resin, polystyrene resin, acrylic resin, methacrylic resin, polyacrylamide resin, polyamide resin, polyvinyl pyridine resin, cellulose based resins, polyurethane resin, epoxy resin, silicone resin, polyvinyl alcohol resin, polyvinyl pyrrolidone resin, casein, vinyl chloride—vinyl acetate based copolymers such as vinyl chloride—vinyl acetate copolymer, hydroxy-modified vinyl chloride—vinyl acetate copolymer, carboxyl-modified vinyl chloride—vinyl acetate copolymer, and vinyl chloride—vinyl acetate—maleic anhydride copolymer, insulating resins such as styrene-butadiene copolymer, vinylidene chloride—acrylonitrile copolymer, styrene-alkyd resin, silicone-alkyd resin, and phenol-formaldehyde resin, and organic photoconductive polymers such as poly-N-vinyl carbazole, polyvinyl anthracene, and polyvinyl perylene for example, it is not limited to these polymers. Also, these binder resins can be used either singly as one type or as a combination of two or more types in arbitrary ratios and assemblage.

Listed as examples of the binder resin used for the charge transportation layer 77 are polyvinyl acetal based resins, polyarylate resin, polycarbonate resin, polyester resin, modified ether based polyester resins, phenoxy resin, polyvinyl chloride resin, polyvinylidene chloride resin, polyvinyl acetate resin, polystyrene resin, acrylic resin, methacrylic resin, polyacrylamide resin, polyamide resin, polyvinyl pyridine resin, cellulose based resins, polyurethane resin, epoxy resin, silicone resin, polyvinyl alcohol resin, polyvinyl pyrrolidone resin, casein, vinyl chloride—vinyl acetate based copolymers, styrene-butadiene copolymer, vinylidene chloride—acrylonitrile copolymer, styrene-alkyd resin, silicone-alkyd resin, phenol-formaldehyde resin, and organic photoconductive resins. Examples of the vinyl chloride—vinyl acetate based copolymers are vinyl chloride—vinyl acetate copolymer, hydroxy-modified vinyl chloride—vinyl acetate copolymer, carboxyl-modified vinyl chloride—vinyl acetate copolymer, and vinyl chloride—vinyl acetate—maleic anhydride copolymer. Examples of the organic photoconductive resins are poly-N-vinyl carbazole, polyvinyl anthracene, and polyvinyl perylene.

Among these, polyarylate resin and polycarbonate resin are preferable and polyarylate resin is more preferable.

An example of the charge transporting agent (charge transporting material) is one containing one type or multiple types (at least one kind) of the charge transporting substance. Although the types of the charge transporting substance are not particularly limited, examples are aromatic amine derivative, stilbene derivative, butadiene derivative, hydrazone derivative, carbazole derivative, aniline derivative, and enamine derivative. Other than these, the charge transporting substance can be a compound of one type or multiple types of the above-mentioned aromatic amine derivative bonded for example. Also, the charge transporting substance can be a polymer having a group consisting of the above-mentioned aromatic amine derivative or the like as its main chain or side chain (electron-donating material) for example. Among all, the charge transporting substance should preferably be aromatic amine derivative, stilbene derivative, hydrazone derivative, enamine derivative, and compounds of one type or multiple types of them bonded, and more preferably a compound of aromatic amine derivative and enamine derivative bonded.

The individual layers constituting the photosensitive drum 13 are normally formed by sequentially applying the application liquid containing materials constituting the individual layers onto the conductive supporting body 74 by repeating application and drying processes using a publicly-known application method. Listed as examples of the solvent and dispersion medium used for dissolving the binder resin to prepare the application liquid are saturated aliphatic solvents such as pentane, hexane, octane, and nonane, aromatic solvents such as toluene, xylene, and anisole, halogenated aromatic solvents such as chlorobenzene, dichlorobenzene, and chloronaphthalene, amide based solvents such as dimethyl formaldehyde and N-methyl-2-pyrrolidone, alcohol based solvents such as methanol, ethanol, isopropanol, n-butanol, and benzyl alcohol, aliphatic polyhydric alcohols such as glycerine and polyethylene glycol, chain, branched, and cyclic ketone based solvents such as acetone, cyclohexane, methyl ethyl ketone, and 4-methoxy-4-methyl-2-pentanone, ester based solvents such as methyl formate, ethyl acetate, and n-butyl acetate, halogenated hydrocarbon based solvents such as methylene chloride, chloroform, and 1,2-dichloroethane, chain and cyclic ether based solvents such as dimethyl ether, dimethoxy ethane, tetrahydrofuran (hereafter called “THF” as appropriate), 1,4-dioxane, methyl cellosolve, and ethyl cellosolve, aprotonic polar solvents such as acetonitrile, dimethyl sulfoxide, sulfolane, and hexamethylphosphoric triamide, nitrogen-containing compounds such as n-butylamine, isopropanol amine, diethylamine, triethanolamine, ethylenediamine, triethylenediamine, and triethylamine, mineral oils such as ligroin, and water, and preferably used are those that do not dissolve the above-mentioned undercoat layer. Note that these can be used either singly as one type or as a combination of two or more types in arbitrary ratios and assemblage.

The application liquid for forming layers in the case of the monolayer photosensitive body or the stacked photosensitive body should normally have a solid content concentration of 5 wt. % or higher, preferably 10 wt. % or higher, and its upper limit should normally be 40 wt. % or lower, preferably 35 wt. % or lower. Also, the viscosity of the application liquid should normally be 10 [mPa·s] or higher, preferably 50 [mPa·s] or higher, and its upper limit should normally be 500 [mPa·s] or lower, preferably 400 [mPa·s] or lower.

In the case of the charge generation layer of the stacked photosensitive body, the solid content concentration should normally be 0.1 wt. % or higher, preferably 1 wt. % or higher, and its upper limit should normally be 15 wt. % or lower, preferably 10 wt. % or lower. Also, the viscosity of the application liquid should normally be 0.01 [mPa·s] or higher, preferably 0.1 [mPa·s] or higher, and its upper limit should normally be 20 [mPa·s] or lower, preferably 10 [mPa·s] or lower.

Listed as examples of the method of applying the application liquid are the dip coating method, the spray coating method, the spinner coating method, the bead coating method, the wire bar coating method, the blade coating method, the roller coating method, the air knife coating method, and the curtain coating method. However, other publicly-known methods can also be used. Note that these methods can be used either singly as one type or as an arbitrarily combination of two or more kinds. Drying after applying the application liquid should preferably be performed by drying to the touch at the room temperature (normally 25° C.), and afterwards heat-drying with no wind or blowing air, normally within a temperature range of 30 [° C.] or higher and 200 [° C.] or lower, normally for 1 minute or more and 2 hours or less. Also, the heating temperature can be either constant or changed while drying.

The film thickness of the photosensitive layer of the monolayer photosensitive body should normally be 5 [μm] or less, preferably 50 [μm] or more. Also, although the film thickness of the charge transportation layer of the sequentially-stacked photosensitive body is normally within a range of 5 [μm] or more and 50 [μm] or less, it should preferably be 10 [μm] or more and 45 [μm] or less from the viewpoint of long life and image stability, and more preferably be 10 [μm] or more and 30 [μm] or less from the viewpoint of high resolution.

Actions of the above-mentioned configuration are explained.

First of all, actions of the development device when forming an image are explained based on FIGS. 1, 2, and 3.

Accompanying the rotation of the drive motor 35 controlled by the drive controller 55, the photosensitive drum 13, the development roller 11, and the toner supply roller 12 rotate in directions indicated with arrows in FIG. 1.

In this embodiment, the print speed of the image forming apparatus 10 was set equivalent to 40 [ppm] (pieces/minute) in the longitudinal-direction printing on A4 sheets as the recording medium P.

In the development device 20 shown in FIG. 1, the toner supply roller 12 provided with a foamed elastic layer that is a spongy elastic body rotates while carrying toner 17 on the outer circumferential face and inside the cell and reaches a contact part with the development roller 11. Note that to the toner supply roller 12 a direct current of −330 [V] is applied by the toner supply roller power source 45. Also, to the development roller 11 a direct current voltage of −200 [V] is applied by the development roller power source 44. Then, toner 17 charged negatively by a potential difference occurring between the development roller 11 and the toner supply roller 12 is supplied to the development roller 11.

Toner 17 carried on the surface of the development roller 11 is formed into a thin layer by the development blade 15 to which a direct current voltage of −330 [V] is applied by the development blade power source 47.

Also, to the charging roller 14 a direct current voltage of −1000 [V] is applied by the charging roller power source 46. Thereby, the surface of the photosensitive drum 13 is uniformly charged. Then, to an electrostatic latent image formed on the photosensitive drum 13 through an exposure by the LED head 26, toner 17 carried by the development roller 11 is supplied, developing the electrostatic latent image.

Toner 17 on the development roller 11 that was not supplied to the photosensitive drum 13 is scraped off by the toner supply roller 12 on the opposing part of the toner supply roller 12.

Toner 17 that was developed by the photosensitive drum 13 and not transferred to the recording medium P, and the external additive released from the toner base particles and adhering to the surface of the photosensitive drum 13 is carried to the contact part of the cleaning blade 16 and scraped off.

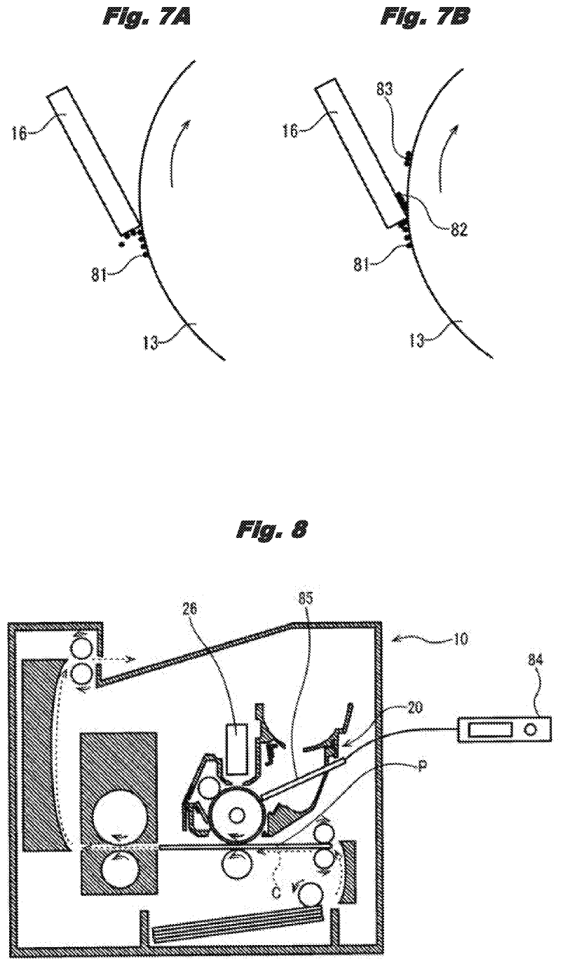

Next, dusty dirt is explained utilizing FIGS. 7A and 7B.

If the amount of the added charge transporting substance is increased in order to decrease the post-exposure potential, that is, increase charge mobility from the charge generation layer to the charge transportation layer surface, even if charge mobility increases, the elastic property of the binder resin in the charge transportation layer may be damaged, thereby its creep property (distortion resistance) may worsen, in which case a part of the photosensitive drum surface in contact with the cleaning member becomes easily deformable. If the photosensitive drum surface deforms, the cleaning member becomes unable to follow the surface shape of the photosensitive drum, thereby an external additive of toner as a developer slips through. The external additive of toner that slipped through the cleaning member may accumulate and aggregate on the cleaning member surface, and upon reaching a certain size, it may collapse, and the collapsed external additive aggregate may migrate to the photosensitive drum surface, inhibiting charging of the photosensitive drum surface by the charging roller and generating dust-like dirt (hereafter called “dusty dirt”) on a formed image, that is a problem.

If no dusty dirt occurs, as shown in FIG. 7A, transfer residual toner and a toner external additive 81 adhering to the surface of the photosensitive drum 13 are scraped off by the cleaning blade 16.

On the other hand, as shown in FIG. 7B, the toner external additive 81 adhering to the surface of the photosensitive drum 13 may not be sufficiently scraped off by the cleaning blade 16 and may slip through it. The external additive 81 that slipped through the cleaning blade 16 accumulates on the surface of the cleaning blade 16 opposing the photosensitive drum 13, and aggregates. When the aggregated external additive 82 grows to a certain size, it collapses, becomes an external additive aggregate 83, and falls from the cleaning blade 16 surface onto the photosensitive drum 13 surface. The external additive aggregate 83 that fell onto the surface of the photosensitive drum 13 becomes several 10 s—several 100s [μm] in size, and while still adhering to the photosensitive drum 13 surface, enters a charging process by the charging roller 14. The part of the photosensitive drum 13 surface to which the external additive aggregate 83 adheres is not charged to a desired potential, and toner 17 is developed in the development process by the development roller 11 and transferred onto the recording medium P. On the recording medium P, it appears as a dust-like color point (dusty dirt) of several 10 s—several 100s [μm] in size.

Next, explained is the method of measuring the post-exposure potential of the photosensitive drum 13 utilizing FIG. 8.

As shown in FIG. 8, the post-exposure potential of the photosensitive drum 13 was measured by removing toner 17, the development roller 11, the toner supply roller 12, the development blade 15, the cleaning blade 16, and the toner cartridge 22 as a toner accommodating part from the development device 20, installing a probe 85 of a surface potentiometer (Model 344) 84 manufactured by Trek, Inc. on the contact position between the photosensitive drum 13 and the development roller 11, and having the LED head 26 perform full exposure. Time for the surface of the photosensitive drum 13 to move from a position exposed by the LED head 26 to a position developed by the development roller 11 was set to 0.04˜0.06 [s (second)].

Note that the linear speed of the photosensitive drum 13 for 0.04 [s (second)] was 234.0 [mm/s], and the linear speed of the photosensitive drum 13 for 0.06 [s (second)] was 182.79 [mm/s].

Next, explained is the method of print tests performed for checking the effects of this embodiment.

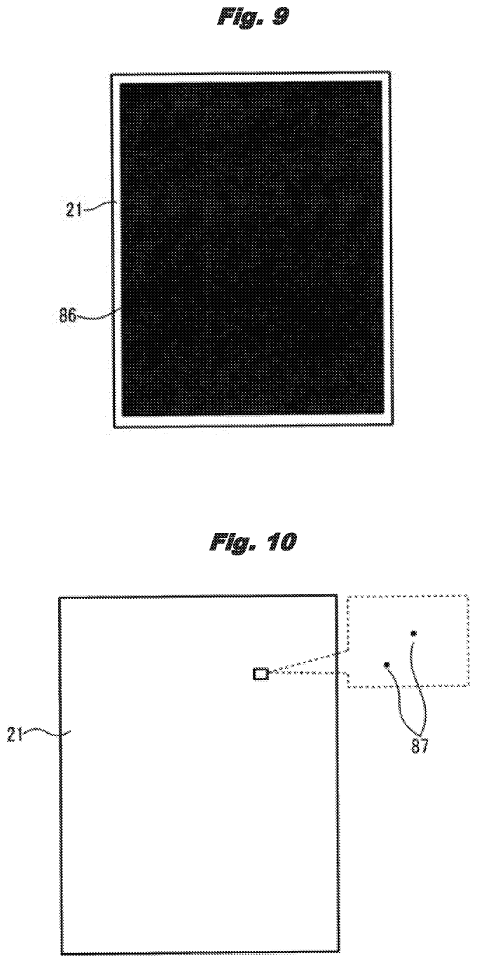

As for a test for checking the presence of dusty dirt occurrences, continuous sheet feeding was performed with a solid pattern 86 shown in FIG. 9. The reason to perform continuous sheet feeding with a solid pattern (printed image density 100%) is that the transfer residual toner amount would become large, therefore toner 17 and the toner external additive 81 recovered by the cleaning blade 16 would increase. The evaluation environment was set to 10,000 pieces at temperature 25 [° C.] and relative humidity 50 [%], 10,000 pieces at temperature 27 [° C.] and relative humidity 80 [%], and 10,000 pieces at temperature 10 [° C.] and relative humidity 20 [%], totaling in 30,000 pieces. Also, at every 10,000 pieces, a blank pattern (printed image density 0%) was printed to check the presence of dusty dirt 87 shown in FIG. 10.

Note that area ratio 100% printing when solid printing over the whole surface of the printable range of a prescribed region (e.g., one round of the photosensitive drum or one page of the print medium) is denoted as printed image density 100%, and printing over an area of 0% relative to this printed image density 100% is denoted as printed image density 0%.

If the number of dots actually used in printing when the photosensitive drum made Cd rotations, that is, the number of exposed dots is denoted as Cm(i), and the number of dots per one rotation of the photosensitive drum, that is, irrespective of the presence of exposure, the number of dots that can be (potentially) printed per one rotation of the photosensitive drum and are used for a sold image tentatively is denoted as C0, the printed image density is expressed by the following formula.

Printed image density=[Cm(i)/(Cd×C0)]×100[%]

Note that Cd×C0 is the number of dots that are (potentially) printable when the photosensitive drum makes Cd rotations.

As for a test to check the amount of post-exposure potential increase after continuous electrification, using the image forming apparatus and the development device of a configuration shown in FIG. 8, 2-hour continuous sheet feeding was performed with full exposure by the LED head 26 in an environment of temperature 27 [° C.] and relative humidity 80 [%].

Concerning dusty dirt, among the total of 30,000 pieces printed in the individual environments, cases with no occurrence at all were judged as effective. Also, concerning the post-exposure potential increase, cases where the amount of potential increase after continuous electrification was 20 [V] or less were judged as effective. The reason for setting the criteria to 20 [V[ or less is that if the amount of post-exposure potential increase exceeds 20 [V], a print density decline (especially in a half tone) becomes outstanding.

Tests in this embodiment were performed by changing the molecular weight of the binder resin in the charge transportation layer 77 and the molecular weight and the added amount of the charge transporting agent in the charge transportation layer 77 of the photosensitive drum 13.

In this embodiment, polyarylate resin was used as the binder resin in the charge transportation layer 77. Note that polyarylate resin can be obtained by a publicly-known synthesis method (e.g., a manufacturing method disclosed in Japanese Unexamined Patent Application No. 2018-172466).

As a method to modify the molecular weight of the binder resin, an interfacial polymerization method using a molecular weight modifier was adopted. Listed as examples of the molecular weight modifier are alkylphenols such as phenol, o,m,p-cresol, o,m,p-ethylphenol, o,m,p-propylphenol, o,m,p-(tert-butyl)phenol, pentylphenol, hexylphenol, octylphenol, nonylphenol, 2,6-dimethylphenol derivative, and 2-methylphenol derivative; monofunctional phenols such as o,m,p-phenylphenol; and monofunctional acid halides such as acetyl chloride, butyryl chloride, octyl acid chloride, benzoyl chloride, benzenesulfonyl chloride, benzenesulfinyl chloride, sulfinyl chloride, benzenphosphonyl chloride, and their substitutions. Among these molecular weight modifiers, the ones having high molecular weight modifying performance and preferable solution stability are o,m,p-(tert-butyl)phenol, 2,6-dimethylphenol derivative, and 2-methylphenol derivative. Especially preferable are p-(tert-butyl)phenol, 2-3,6-trimethylphenol, and 2,3,5-trimethyl phenol.

Also, as the interfacial polymerization method, the following method was used. First, as a water phase, an alkaline solution of bisphenols is prepared, subsequently a polymerization catalyst, and further a molecular weight modifier (terminal blocking agent) as necessary are added. Furthermore, an organic phase is prepared by mixing dicarboxylic acid chloride that is a raw material for polymerizing the dicarboxylic acid component into a solvent for preparing the organic phase. Afterwards, the organic phase solution is mixed into the water phase solution, an interfacial polymerization reaction is performed while stirring it for 1˜5 hours at 25° C. or lower, thereby polyarylate of a high molecular weight can be obtained. At this time, polymers (reaction products) of high molecular weights exist in the organic phase.

Also, in this embodiment, used as the charge transporting agents were compounds of aromatic amine derivative and enamine derivative bonded. Note that although two types of charge transporting agents were used in this embodiment, three or more types of charge transporting agents can be used.

Note that the charge transporting agents can be obtained by a publicly-known synthesis method (e.g., a manufacturing method disclosed in Japanese Unexamined Patent Application No. 2018-172466). Also, the molecular weights of the charge transporting agents can be modified by changing the number of carbons of alkyl group, alkoxy group, phenyl group, etc. using a publicly-known method.

Test results of this embodiment are shown in Table 1. Note that in this embodiment, a compound using aromatic amine derivative was adopted as a charge transporting agent 1, and a compound using enamine derivative as a charge transporting agent 2.

[Table 1]

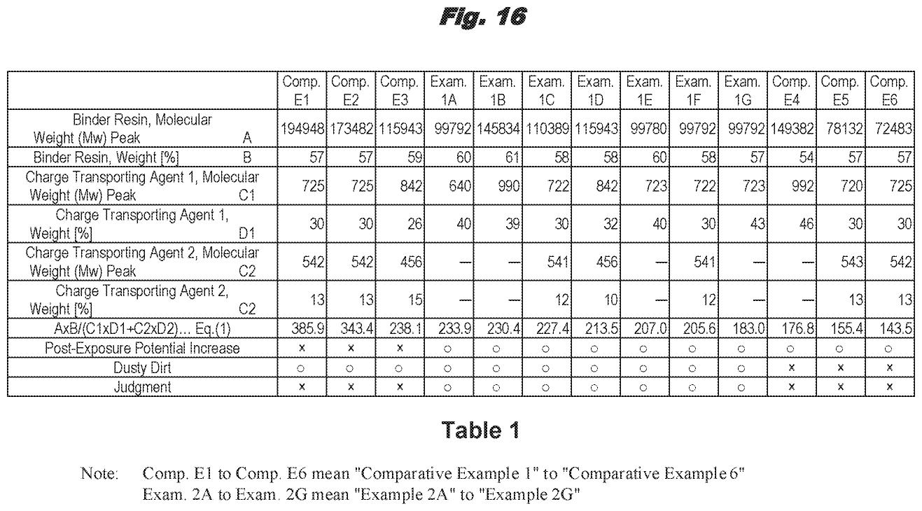

(See FIG. 16)

The weight-average molecular weights (Mw) of the binder resin and the charge transporting agents were measured by GPC (gel permeation chromatography). Listed in Table 1 are peak molecular weights (A, C1, C2) and area ratios (i.e., weight ratios B, D1, D2) of individual peaks of the molecular weight distribution. After making a cut on the photosensitive drum 13 surface, the photosensitive layer 73 was peeled off, and the peeled-off photosensitive layer 73 was dissolved with THF at a concentration of about 3 [mg/l] for the measurement.

In this embodiment, selected as a solvent to dissolve the photosensitive layer 73 was THF that is insoluble in the charge generation layer 76 and soluble in the charge transportation layer 77.

To describe the specific measurement method, the peeled-off photosensitive layer 73 was injected to THF, left alone for 1 hour in a 40° C. environment, and the charge transportation layer 77 was dissolved.

Afterwards, the solution where the charge transportation layer 77 was dissolved was extracted with a syringe, and afterwards filtered with an HPLC preprocessing filter of 0.45 μm in pore size (Chromatodisk 25N manufactured by KURABO Industries, Ltd.)

The filtered solution was extracted by 200 μL (microliter) and measured by a GPC measuring instrument.

In this embodiment, used is the photosensitive drum constituted of the charge transportation layer 77 of 20±1 μm in film thickness, the charge generation layer 76 of 1±0.2 μm in film thickness, and the undercoat layer 75 of 1±0.2 μm in film thickness, where the film thickness of the charge transportation layer 77 is remarkably greater than the film thickness of the charge generation layer 76. That is, the main ingredient of the peeled-off photosensitive layer 73 is the charge transportation layer 77, and even if part of the charge generation layer 76 is dissolved in THF, it is believed that the main component of the filtered solution would be ingredients contained in the charge transportation layer 77.

The weight-average molecular weights (Mw) of the binder resin and the charge transporting agents in this embodiment are measured by GPC (gel permeation chromatography) using polystyrene as the standard material. An example of more detailed measurement conditions is shown below.

Device: A gel permeation chromatography system consisting of LC-20AD, SIL-20A HT, CBM-20A, RID-20A, and CTO-20A manufactured by Shimadzu Corporation

Column: TSKgel Super HM-M, 6 mm I. D.×15 cm (manufactured by Tosoh Corporation) 2 pieces

Standard material: Polystyrene (manufactured by Tosoh Corporation)

Flow speed: 0.6 ml/min

Solvent: Tetrahydrofuran

Temperature: 40° C.

Detector: R.I (Refractive Index detector), UV (254 nm)

A profile outputted as the weight-average molecular weight distribution of the charge transportation layer 77 is as shown in FIG. 11, and based on analysis results using analysis software “LabSolutions” (manufactured by Shimadzu Corporation) bundled with the above-mentioned gel permeation chromatography system, peak molecular weights and area ratios (added weight ratios) of the individual peaks were obtained.

In the molecular weight distribution obtained by the GPC measurement as shown in FIG. 11, molecular weights showing the highest value on the vertical axis are regarded as the peak molecular weights of the individual peaks of the binder resin and the charge transporting material. Note that three peaks are apparent in FIG. 11.

Also, in FIG. 11, weight-average molecular weight is plotted in exponent on the horizontal axis. In the above-mentioned molecular weight distribution, the left side becomes the low molecular weight side, and the right side the high molecular weight side. Here, a peak near 1.E+05 on the horizontal axis in FIG. 11 is regarded as that of the binder resin, and two peaks near 1.E+03 as those of the charge transporting material.

Note that the molecular weight peak of the binder resin used for the charge transportation layer 77 should preferably be 10000 or higher, and the molecular weight peaks of the charge transporting material lower than 10000. It is more preferable if the molecular weight peaks of the charge transporting material are 100 or higher and 2000 or lower, and the molecular weight peak of the binder resin 50000 or higher.

In this embodiment, used were the charge transporting material having molecular weight peaks of 456 or higher and 990 or lower, and the binder resin having a molecular weight peak of 72483 or higher and 194948 or lower.

Note that toner used in this embodiment is measured by performing an elemental analysis on the surface of the toner using EDX energy dispersive fluorescent X-ray analysis (or EDX (Energy Dispersive X-ray) spectrometry). In an elemental analysis using EDX, for example, an energy dispersive fluorescent X-ray analyzer EDX-800HS manufactured by Shimadzu Corporation is used. In this case, for example, the analysis environment is set to helium (He) gas atmosphere and X-ray tube voltages of 15 kV and 50 kV.

Toner in this embodiment has multiple types of silica added as external additives, and the amount of silica detected by the elemental analysis of the toner using EDX was within a range of 3.144˜4.188 wt. %.

In Table 1, cases where dusty dirt occurred are indicated with “×”, and cases with no such occurrence with “0”. Also, cases where the amount of post-exposure potential increase was 20 [V] or more are indicated with “×”, and cases of 20 [V] or less with “O”. Cases where both dusty dirt and post-exposure potential increase are indicated as “O” are regarded that the photosensitive drum 13 has long-term performance stability because no dusty dirt occurred and the amount of post-exposure potential increase was small.

Cases where the photosensitive drum 13 had no dusty dirt occurring and the post-exposure potential increase suppressed 20 [V] or less were Embodiments 1A-1G. In these cases, the ratio (or photosensitive ratio) of first product (A×B) of the weight-average molecular weight distribution peak molecular weight A and the added ratio B of the binder resin to second product that is a sum of products (C1×D1, C2×D2) of the weight-average molecular weight distribution peak molecular weights (C1, C2) and the added ratios of the charge transporting agents (D1, D2) shown as Formula (1) was within a range of 183.0 or higher and 233.9 or lower.

In the embodiment, the added ratio B of the binder resin is obtained by dividing “weight amount of charge transporting agent (P)” with a combination of “weight amount of binder resin (Q)” and “weight amount of charge transporting agent (P).” Simply noting, B=P/(Q+P).

A×B/(C1×D1+C2×D2) Formula (1)

where “C” means a peak molecular weight of a weight-average molecular weight distribution of one charge transporting agent, supplemental integers “1” and “2” indicate the type of the charge transporting agents. C1 means the peak molecular weight of 1st charge transporting agent, C2 means the peak molecular weight of 2nd charge transporting agent, Cn means the peal molecular weight of Nth charge transporting agent.

“D” means added ratio thereof, and D1 means the added ration of 1st charge transporting agent, C2 means the added ratio of 2nd charge transporting agent.

The ratio may be represented with

A×B/sum(C1×D1+C2×D2 . . . Cn+Dn) Formula (1′)

A×B/ΣCn×Dn Formula (1″)

where integer “n” means the number of types of charge transporting agents. Formula (1) above represents a case where N is 2.

That is, the value of the ratio of the product of the weight-average molecular weight distribution peak molecular weight A and the added ratio B of the binder resin to the sum of the products of the weight-average molecular weight distribution peak molecular weights (Cn) and the added ratios (Dn) of the charge transporting agents was contained within the range of 183.0 or higher and 233.9 or lower. The ratio obtained from Formula (1) may be called a photosensitive ration or a charge transporting ratio in this application.

Based on the above results, it is evident that the molecular weight of the binder resin and the molecular weight and the added amount of the charge transporting agents in the charge transportation layer 77 contribute to dusty dirt occurrences and the post-exposure potential increase.

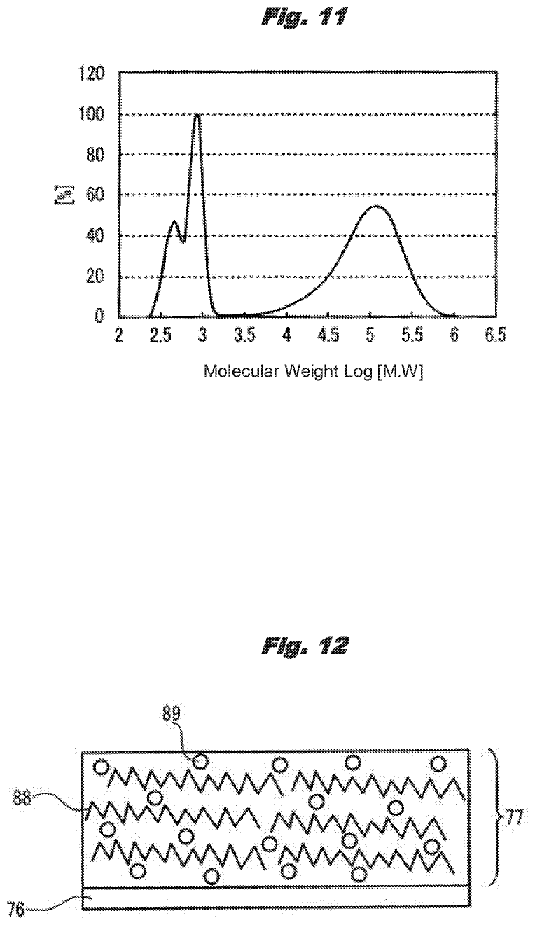

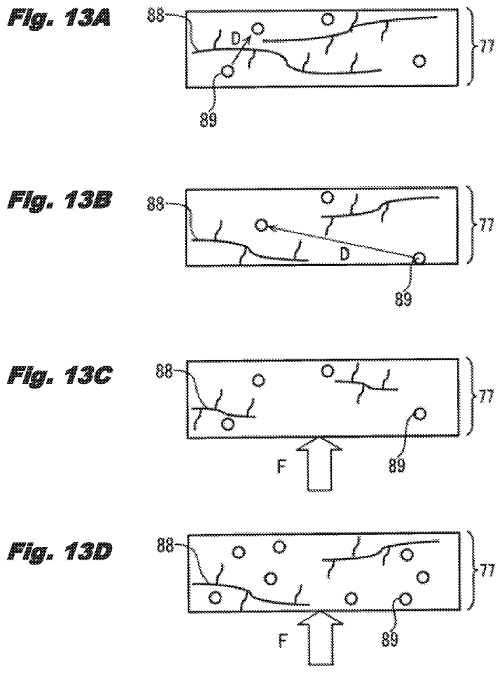

The reasons of the post-exposure potential increased and dusty dirt occurred in Comparison Examples 1˜3 and Comparison Examples 4˜6, respectively, are explained utilizing an explanatory diagram of the charge transportation layer in the first embodiment in FIG. 12 and an explanatory diagram of actions of the charge transportation layer in the first embodiment in FIGS. 13A to 13D.

In FIG. 12, the charge transportation layer 77 stacked on the charge generation layer 76 is mainly constituted of a binder resin 88 and charge transporting agents 89.

Note that in FIGS. 13A to 13D an arrow D indicates a concept of a charge transfer between the charge transporting agents 89, where the charge transporting agents 89 themselves do not move.

Cases where the value of Formula (1) becomes large as in Comparison Examples 1˜3 occur when the molecular weight of the binder resin 88 is large, or the added amounts or the molecular weights of the charge transporting agents 89 are small.

In order to enhance the mechanical properties of the charge transportation layer 77 that is the outermost layer of the photosensitive drum 13, if the molecular weight of the binder resin 88 is increased, side chains etc. that do not contribute to charge movement increase in the resin, thereby decreasing paths for charges of the charge transporting agents 89 generated in the charge generation layer 76 to move as shown in FIG. 13A, increasing the post-exposure potential. Also, after continuous electrification, influenced by traps (deep energy levels created by impurities and lattice defects contained in high molecules), the post-exposure potential further increases. Note that FIG. 13A shows a state where due to high molecular chains of the binder resin 88, charge transfers between the charge transporting agents 89 are inhibited and slow down.

Also, when the molecular weights of the charge transporting agents 89 are small, or their added amounts are small, as shown in FIG. 13B, because the number of paths for charge movement becomes small, charge mobility is damaged, thereby the post-exposure potential becomes high. Note that FIG. 13B shows a state where because the amounts of the charge transporting agents 89 are small, charge transfers slow down.

Cases where the value of Formula (1) becomes small as in Comparison Examples 4˜6 occur when the molecular weight of the binder resin 88 is small, or the molecular weights or the added amounts of the charge transporting agents 89 are large.

If the molecular weight of the binder resin 88 becomes small, as shown in FIG. 13C, because the macromolecular chains of the binder resin 88 are short, the charge transportation layer 77 develops large dents due to pressure from a contact member (pressure indicated with an arrow F in FIG. 13C) and becomes easy to deform. Accompanying the deformation of the charge transportation layer 77, in the contact part with the cleaning blade 16 shown in FIG. 7B, tiny space is formed, and the toner external additive 81 slips through and generates the external additive aggregate 83, causing dusty dirt to occur.

If the molecular weights or the added amounts of the charge transporting agents 89 are large, the charge transporting agents 89 existing between molecules of the binder resin 88 increase as shown in FIG. 13D, therefore time after the binder resin 88 deforms by receiving pressure (pressure indicated with an arrow F in FIG. 13D) until it returns to the original state becomes longer, or it becomes difficult to return to the original state (becomes easy to deform plastically). Thereby, in the contact part with the cleaning blade 16, tiny space is formed, and the toner external additive 81 slips through and generates the external additive aggregate 83, causing dusty dirt to occur.

As stated above, in this embodiment, by optimizing the molecular weights and the added amounts of the binder resin 88 and the charge transporting agents 89 in the charge transportation layer 77 of the photosensitive drum 13, charge mobility can be improved, thereby suppressing the post-exposure potential increase after continuous electrification, and deformation (distortion) of the charge transportation layer 77 can be suppressed, thereby suppressing dusty dirt occurrences caused by the external additive 81 of toner 17 that slipped through the cleaning blade 16.

Specifically, the development device 20 is provided with the photosensitive drum 13 where the ratio of the product of the molecular weight and the added ratio of the binder resin 88 to the total sum of the products of the molecular weights and the added ratios of the charge transporting agents 89 in the charge transportation layer 77 becomes 183.0 or higher and 233.9 or lower. Note that the above-mentioned molecular weights are peak molecular weights in the weight-average molecular weight distribution measured by gel permeation chromatography (GPC). Also, the added ratios are the added weight ratios [%] of the binder resin and the charge transporting agents constituting the charge transportation layer.

Also, the weight-average molecular weight of the binder resin 88 in the charge transportation layer 77 is set to 99792 or higher and 145834 or lower.

Note that if the charge transporting agent 89 is made one kind, it becomes easily influenced by a high-temperature and high-humidity environment and traps after electrification. However, adopting two or more types of the charge transporting agent 89 allows suppressing the post-exposure potential increase after continuous electrification and dusty dirt occurrences caused by the external additive 81 of toner 17 that slipped through the cleaning blade 16 without decreasing the charge transporting agents 89.

As explained above, obtained in the first embodiment is the effect that dusty dirt occurrences in images formed by the development device can be suppressed.

Also, obtained is the effect that the post-exposure potential increase after continuous electrification in the photosensitive drum can be suppressed.

### Embodiment 2

In the second embodiment, the Martens hardness of the charge transportation layer of the photosensitive drum 13 in the first embodiment shown in FIG. 1 is regulated to improve durability of the photosensitive drum 13.

Note that except for the Martens hardness of the charge transportation layer of the photosensitive drum 13, the configuration of an image forming apparatus and a development device in the second embodiment are the same as in the first embodiment mentioned above, therefore the same codes are added and their explanations are omitted.

Here, life of a photosensitive drum is explained utilizing FIGS. 1 and 6.

A charge transportation layer 77 of a photosensitive drum 13 shown in FIGS. 1 and 6 is formed as a film of 18˜24 μm in thickness, and wear occurs by being rubbed by contact members such as a development roller 11 and a cleaning blade 16 when performing a print operation. If the charge transportation layer 77 becomes 10 μm or thinner due to this wear, a charge from a charging roller 14 cannot be retained, the potential of an electrostatic latent image decreases, thereby toner 17 is supplied to a non-printing region, generating printing blot. Therefore, if the wear property of the charge transportation layer 77 is good, the photosensitive drum 13 has long life, suppressing printing blot occurrences.

The above-mentioned wear property has a correlation with the Martens hardness of the charge transportation layer 77. If the Martens hardness of the charge transportation layer 77 is low, deformation of the photosensitive drum 13 surface becomes large. Therefore, pressure acting between the photosensitive drum 13 and the development roller 11 and the cleaning blade 16 that are contact members of the photosensitive drum 13 is reduced. Thereby, if the Martens hardness of the charge transportation layer 77 is low, wear due to rubbing with the contact members can be suppressed, improving the wear property.

Next, explained is the method of measuring Martens hardness.

Martens hardness in this embodiment is a value measured using a micro hardness meter Nano Indenter G200 manufactured by Agilent Technologies, Inc. in an environment of temperature 25° C. and relative humidity 50%.

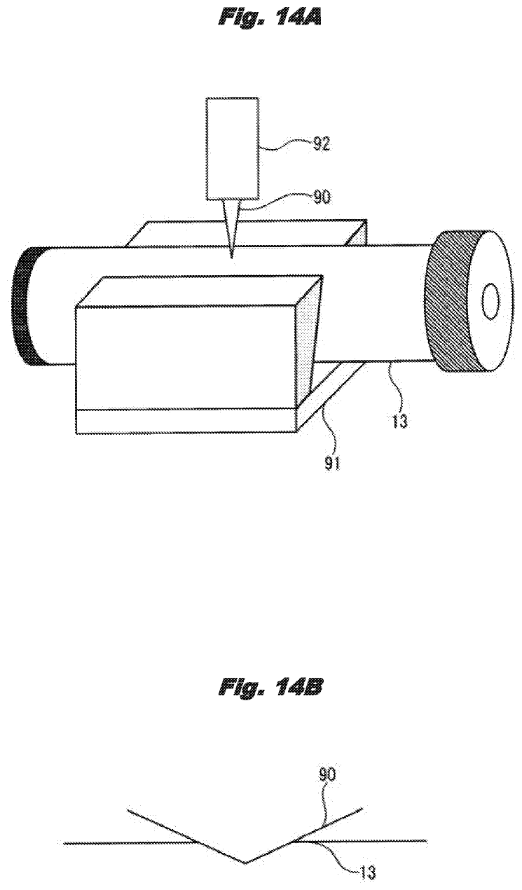

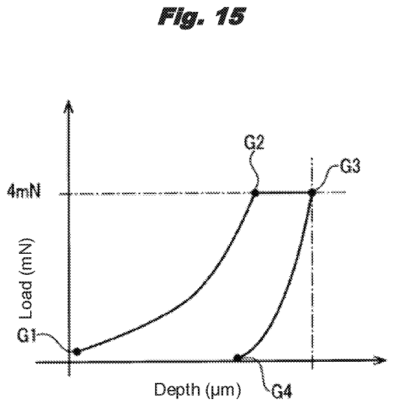

FIGS. 14A and 14B are explanatory diagrams of the method of measuring Martens hardness in the second embodiment.

As shown in FIG. 14A, the photosensitive drum 13 is fixed to a holder 91, and an indenter 90 installed in a load control mechanism 92 is loaded vertically on the the photosensitive drum 13 surface. For the measurement, used as the indenter 90 is a pre-mounted Berkovich-diamond indenter having a 145-degree included angle between faces. Also, Martens hardness is measured by an indentation test.

The indentation test is explained.

The measurement conditions are set as listed below. The load to the indenter 90 and an indentation depth under the load are continuously read, thereby obtaining a profile as shown in FIG. 15 where the load [mN] is plotted on the Y axis, and the depth [μm] on the X axis.

### [Measurement Conditions]

Allowable heat transfer rate: 1 nm/s
Maximum indentation load: 4 mN
Loading time: 25 s
Load holding time: 30 s
Unloading time: 25 s

Note that shown in FIG. 15 from point G1 to point G2 is a state where the load on the indenter 90 is increasing, from point G2 to point G3 is a state where the maximum indentation load by the indenter 90 is held, and from point G3 to point G4 is a state where the load by the indenter 90 is being removed.

In this embodiment, Martens hardness is a value when indenting was performed up to an indentation load of 4 mN, defined by Formula (2) below from the indentation depth. Note that FIG. 14B shows a state where the indenter 90 is pressed into the photosensitive drum 13.

Martens hardness[N/mm²]=Test load [N]/Surface area [mm²] of Vickers indenter under the test load Formula (2)

Actions of the above-mentioned configuration are explained.

Actions of the second embodiment are the actions of the first embodiment with the following content added.

Listed in Table 2 are the test results of the first embodiment with the Martens hardness values and the wear property results added. The wear property was evaluated from the wear amount of the charge transportation layer after printing 30,000 pieces in total for the individual environments.

[Table 2]

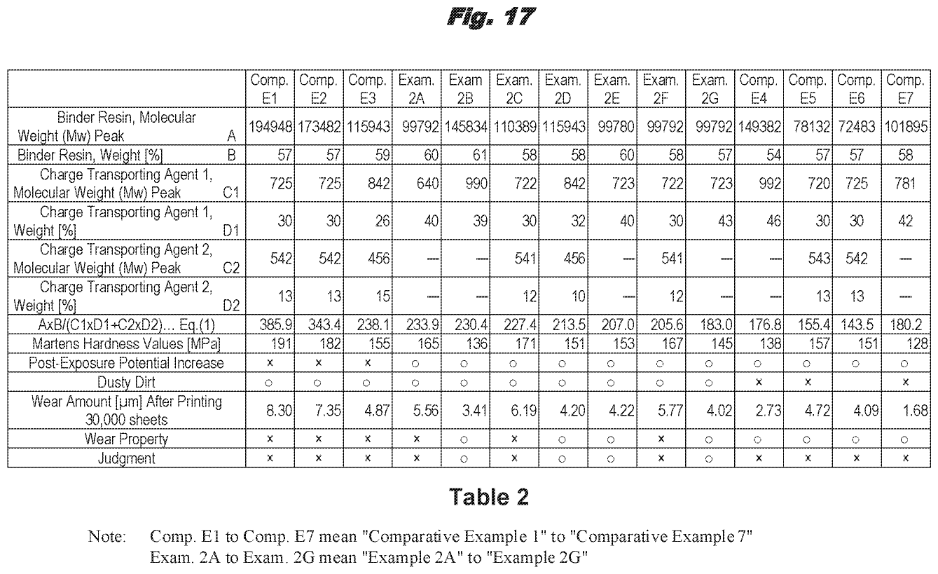

(see FIG. 17)

Here, explained is the method of measuring the wear amount of the charge transportation layer.

First of all, the outer diameter of a new photosensitive drum was measured from an end part of a drum flange 72 shown in FIG. 6 toward a drum gear 71 in the axial direction at 5 mm intervals. Measurements of the outer diameter were performed using an automatic roller measuring machine RM202 manufactured by Apollo Seiko Ltd.

Next, using the photosensitive drum whose outer diameter was measured, 30,000 pieces were printed using the same printing test method as in the first embodiment, and the outer diameter of the photosensitive drum after the printing was measured from the end part of the drum flange 72 shown in FIG. 6 toward the drum gear 71 in the axial direction at 5 mm intervals. The outer diameter differences between the new and the post-printing photosensitive drums in the individual positions were calculated, and the maximum value of the outer diameter differences was regarded as the wear amount of the charge transportation layer.

In Table 2, because the wear amount of a conventional photosensitive drum (Comparison Example 3) after printing 30,000 pieces was 4.87 μm, cases where the wear amount was lower than 4.87 μm were indicated as “0”, and cases of 4.87 μm or higher as “×”.

In Embodiment 2B, if expected life of the photosensitive drum is calculated based on the wear amount, it becomes 42,845 pieces (=(4.87/3.41)×30,000 pieces).

Also, in Embodiment 2D, if expected life of the photosensitive drum is calculated based on the wear amount, it becomes 34,786 pieces (=(4.87/4.20)×30,000 pieces).

Also, in Embodiment 2E, if expected life of the photosensitive drum is calculated based on the wear amount, it becomes 34,621 pieces (=(4.87/4.22)×30,000 pieces).

Also, in Embodiment 2G, if expected life of the photosensitive drum is calculated based on the wear amount, it becomes 36,343 pieces (=(4.87/4.02)×30,000 pieces).

In this manner, by regulating Martens hardness to 136153 [MPa], durability improved from the conventional 30,000 piece printing.

Among Embodiments 2A-2G where the photosensitive drum had no dusty dirt occurrence and its post-exposure potential increase suppressed at 20 [V] or less, when Martens hardness was 153 [MPa] or lower, wear property improved from the conventional product.

If Martens hardness is high, the photosensitive drum surface becomes hard to deform, thereby pressures with the contact members are not relieved. At this time, the wear amount increases due to rubbing between the photosensitive drum and the contact members, the wear property worsens. As shown in Comparison Example 3, when Martens hardness was 153 [MPa] or higher, the wear property worsened from the conventional product.

Also, as shown in Comparison Example 7, when Martens hardness was 135 [MPa] or lower, the photosensitive drum 13 surface became easy to be scratched, and the external additive aggregated in the scratched part, generating an image failure called filming.

Therefore, in order to improve the wear property from the conventional product while suppressing image failures, Martens hardness can be set to 136 [MPa] or higher and 153 [MPa] or lower.

In this manner, in this embodiment, the development device 20 was provided with the photosensitive drum 13 where the ratio of the product of the molecular weight and the added ratio of the binder resin 88 to the total sum of the products of the molecular weights and the added ratios of the charge transporting agents 89 in the charge transportation layer 77 was 183.0 or higher and 233.9 or lower, and the Martens hardness was 136 [MPa] or higher and 153 [MPa] or lower.

As explained above, in addition to the effects of the first embodiment, obtained in the second embodiment is the effect that the wear property of the photosensitive drum can be improved.

Note that although explained as an example of the image forming apparatus in the first embodiment and the second embodiment was a monochrome printer of a direct transfer system having one unit of development device, a color image forming apparatus having multiple development devices or an image forming apparatus of an intermediate transfer system can be adopted. Also, the image forming apparatus can be a copier, a facsimile machine, a multifunction peripheral (MFP), or the like.

What is claimed is:

1. An image carrier unit, comprising:
an image carrier that makes a rotation and has a photosensitive layer on an outer surface, the photosensitive layer containing a binding resin and at least one type of charge transporting material and covering the surface, and
a cleaning blade that has a contact part contacting the surface of the image carrier and removes residue on the surface of the image carrier accompanying the rotation of the image carrier, wherein
a photosensitive ratio of a first product to a second product is 183.0 or higher and 233.9 or lower,
the first product is obtained from a weight-average molecular weight (A) of the binder resin multiplied by an added ratio (B) of the binder resin in the photosensitive layer, and
the second product is obtained from a weight-average molecular weight (C) of the charge transporting material multiplied by an added ratio (D) of the charge transporting material.

2. The image carrier unit according to claim 1, wherein
the photosensitive layer further contains one or more types of charge transporting materials such that the photosensitive layer contains N types of the charge transporting materials each of which is different from others, wherein N is integer two or more,
the second product is a sum of products (Cn×Dn) calculated from the weight-average molecular weights and the added ratios of all the charge transporting materials.

3. The image carrier unit according to claim 2, wherein
the added ratio (B) of the binder resin is obtained by dividing a weight amount of the charge transporting material with a combination of a weight amount of binder resin and the weight amount of the charge transporting material.

4. The image carrier unit according to claim 3, wherein
the added ratio of the charge transporting material is obtained from a weight of the charge transporting material dividing with the weight of the photosensitive layer.

5. The image carrier unit according to claim 2, wherein
the added ratio of the binder resin is obtained from a weight of the binder resin dividing with a weight of the photosensitive layer, and
the added ratios of all the charge transporting materials are respectively obtained from weights of the charge transporting materials dividing with the weight of the photosensitive layer.

6. The image carrier unit according to claim 1, wherein
a Martens hardness of the image carrier is 136 [MPa] or higher and 153 [MPa] or lower.

7. The image carrier unit according to claim 1, wherein
the weight-average molecular weight of the binding resin is 99792 or higher and 145834 or lower.

8. The image carrier unit according to claim 1, wherein
the cleaning blade is in contact with the image carrier with a linear pressure, the liner pressure is 15 [gf/cm] or higher and 30 [gf/cm] or lower.

9. The image carrier unit according to claim 1, wherein
the image carrier is in a cylindrical shape, and
a contact angle (a) between the cleaning blade and the contact part of the image carrier is 10 degrees or more and 15 degrees or less.

10. The image carrier unit according to claim 1, wherein
a linear speed of the image carrier is 234 [mm/s] or lower.

11. The image carrier unit according to claim 1, wherein
the weight-average molecular weight of the binding resin and the weight-average molecular weight of the charge transporting material are peak molecular weights of the weight-average molecular weights that are analyzed by a gel permeation chromatography (or GPC) instrument.

12. The image carrier unit according to claim 2, wherein
the weight-average molecular weight of the binding resin and the weight-average molecular weights of the charge transporting materials are peak molecular weights of the weight-average molecular weights that are analyzed by a gel permeation chromatography (or GPC) instrument.

13. An image carrier unit, comprising:
an image carrier that makes a rotation and has a charge transportation layer on an outer surface, the charge transportation layer containing a binding resin and at least one type of charge transporting material and covering the surface, and
a cleaning blade that has a contact part contacting the surface of the image carrier and removes residue on the surface of the image carrier accompanying the rotation of the image carrier, wherein
a charge transporting ratio of a first product to a second product is 183.0 or higher and 233.9 or lower,
the first product is obtained from a peak molecular weight (A) of the binder resin of the charge transportation layer multiplied by an area ratio (B) of the charge transportation layer,
the second product is obtained from a peak molecular weight (C) of the charge transporting material multiplied by an area ratio (D) of the charge transporting material,
these peak molecular weights and the area ratios of the binding resin and the charge transporting material are measured by gel permeation chromatography measurement on the charge transportation layer.

14. The image carrier unit according to claim 13, wherein
the area ratios (B, D) of the charge transportation layer are each obtained by dividing a peak area of the charge transporting material with a combination of a peak area of the binder resin and the peak area of the charge transporting material.

15. The image carrier unit according to claim 13, wherein
the charge transportation layer further contains one or more types of charge transporting materials such that the charge transportation layer contains N types of the charge transporting materials each of which is different from others, wherein N is integer two or more,
the second product is a sum of products (Cn×Dn) calculated from the peak molecular weights and the area ratios of all the charge transporting materials.

16. The image carrier unit according to claim 13, wherein
the image carrier is provided with a photosensitive layer containing the binding resin and the one type of charge transporting material, and
the gel permeation chromatography measurement uses a solution where the photosensitive layer is dissolved in tetrahydrofuran (or THF).

17. The image carrier unit according to claim 13, wherein
the charge transportation layer is constituted of the binding resin and the charge transporting material.

18. An image forming apparatus that forms a developer image, comprising:
the image carrier unit according to claim 1.
